(19) United States
(12) Patent Application Publication
(10) Pub. No.: US 2007/0234077 A1
(43) Pub. Date: Oct. 4, 2007

(54) Reducing power consumption by load imbalancing

(76) Inventors: Michael A. Rothman, Sammamish, WA (US); Vincent J. Zimmer, Federal Way, WA (US); Robert C. Swanson, Olympia, WA (US); Mallik Bulusu, Olympia, WA (US)

Correspondence Address: TROP PRUNER & HU, PC, 1616 S. VOSS ROAD, SUITE 750, HOUSTON, TX, 77057-2631, US

(21) Appl. No.: 11/395,670

(22) Filed: Mar. 31, 2006

(51) Int. Cl. G06F 1/00

(52) U.S. Cl. 713/300

(57) ABSTRACT

Power consumption may be reduced by imbalancing the loads handled by interchangeable components. Interchangeable components, such as memory devices, processors, servers, or other entities, may be imbalanced to reduce power consumption as circumstances allow. As a result, interchangeable components that are used to implement effectively the same function may be powered down or hot-removed and their duties transferred to other components. As a result, the deactivated component may be powered down to a reduced power consumption state, thereby reducing the overall power consumption of the system.

### BACKGROUND

This invention relates generally to processor-based systems and to techniques for reducing the power consumption of such systems.

Power consumption in processor-based systems is of considerable concern in a wide variety of applications. Power consumption is most pressing in cases of limited power supplies, such as battery powered applications, and in situations where the generation of heat adversely affects the performance of the processor-based system. Examples are numerous. For example, laptop computers run on batteries and the longer the laptop can run on a given battery charge the more desirable is the laptop. Blade servers or other server configurations may include so many devices that overheating may adversely affect the performance of all of the devices.

Thus, there are a number of approaches to reducing power consumption. For the most part, these approaches revolve around reducing the operating speed or frequency of the processor which is the core of the processor-based system. In other words, when power consumption or heat generation is too high, the processor may be throttled to reduce power consumption.

While these efforts have worked well, the increasing heat generation of processor-based devices, and the need for ever improved battery operated devices indicates that further improvements in power consumption would be desirable.

### BRIEF DESCRIPTION of the DRAWINGS

FIG. 1 is a schematic depiction of one embodiment of the present invention;

FIG. 2 is a depiction of the virtual machine shown in FIG. 1 in accordance with one embodiment of the present invention;

FIG. 3 is a schematic depiction of another embodiment of the present invention;

FIG. 4 is a process flow for one embodiment of the present invention; and

FIG. 5 is another embodiment of the present invention.

### DETAILED DESCRIPTION

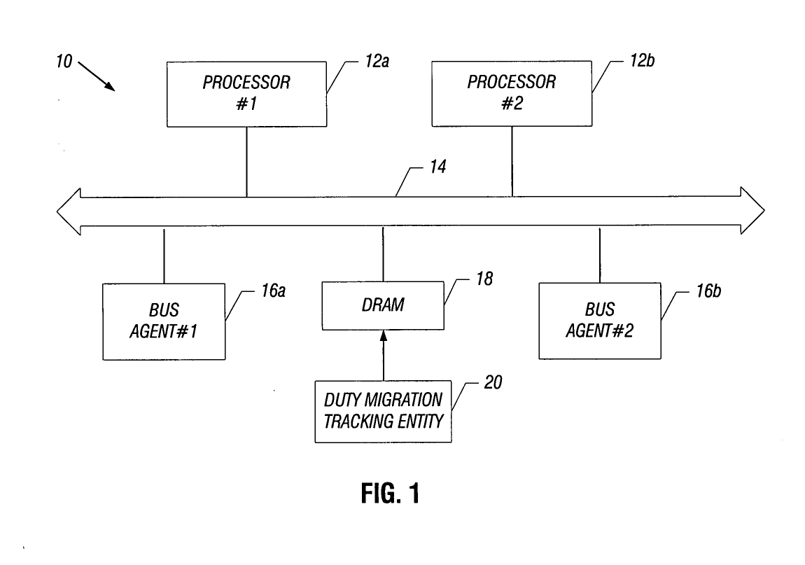

Referring to FIG. 1, in accordance with one embodiment of the present invention, a multiprocessor processor-based system 10 may include a first processor 12aand a second processor 12b. The processors 12a and 12b may be packaged in a single package or may be separately packaged. While two processors have been used for illustration, it will be apparent to one of skill in the art that more than two, or fewer than two, processors may be used in some embodiments.

The processors 12a and 12b are coupled to a bus 14 which, in turn, couples to a first bus agent 16a and a second bus agent 16b. For illustration purposes, also coupled to the bus 14 is a system memory in the form of a dynamic random access memory (DRAM) 18 and a migration tracking entity 20.

An entity 20, such as a virtual machine monitor, software partitioning mechanism, or operating system drivers, in some embodiments, may be implemented in the form of software or firmware. The virtual machine maintains memory state information and traps memory accesses, as well as other hardware accesses in some embodiments. While an embodiment with a virtual machine is discussed herein, those skilled in the art should appreciate that the presence of a virtual machine is not required.

In some embodiments of the present invention, two or more interchangeable components (such as bus agents 16a and 16b or processors 12a and 12b) may be imbalanced for power consumption purposes by offloading tasks done by one such component to another. Thus, two processors 12a and 12b may be imbalanced to improve power consumption by powering down one processor and migrating its duties to another processor. Likewise, the operation of two bus agents 16aand 16b may be imbalanced to improve power consumption.

Load imbalancing may be accomplished by determining, at appropriate times, when the operation of two components that are interchangeable is no longer most efficient or necessary. In such cases, one of the unnecessary components may be powered down to a reduced power consumption state and its duties migrated to the other of the components. A result of the migration is the reduction of the system power consumption.

Examples of interchangeable bus agents 16a and 16binclude a wide variety of components, most notably memory devices such as memory chips or memory cards. The memory devices may be semiconductor memory devices or magnetic memory devices such as hard drives or optical drives. The agents 16a and 16b may also be network controllers, as still a different example. In some cases, each network controller may have its own MAC address. In those cases, when the data throughput is less, it may be possible to migrate the duties of one network controller to another. Likewise, in multiprocessor systems, when the workload on two processors is sufficiently low, the duties of one processor may be migrated to another.

In each of these cases, power consumption may be reduced because maintaining both of the interchangeable components in a non-standby, active, or higher power consumption mode may increase system power consumption. Thus, in some embodiments, a variety of components, including processors, servers, clients, and bus agents, may have different power consumption modes including an active mode in which consumption is higher and a less active mode or powered down mode in which consumption is lower. The powered down mode, in some cases, may not correspond to a power off configuration. Additional time may be required to transition the component from the powered down mode to an active mode to perform a task, but that time may be less than the time needed to transition the component from a power off mode to an active or full power mode.

As an example, in many cases a plurality of interchangeable memory devices may be operating. Systems using those memory devices may not be aware how data being stored in those memory devices is distributed over those interchangeable memory devices. Thus, in some cases, data to be stored is related, but still is distributed between at least two memory devices. Maintenance of those memory devices in an active mode which is suitable for ready access increases system power consumption.

When memory demands are sufficiently low, corresponding, for example, to the situation when a processor may be powered down pursuant to the ACPI specification, at least one of the memory devices may be powered down and the duties of the powered-down memory device migrated to another interchangeable memory device. See Advanced Configuration & Power Interface (ACPI), Revision 3.0a, Dec. 30, 2005.

The migration of the duties may include two aspects. In a first aspect, data which is stored on one memory being transitioned to a lower power consumption mode is migrated for storage on another memory. In a second aspect, subsequent requests for services to the powered down device may be redirected to another memory device.

In some cases, it may be desirable to maintain an entity which keeps track of such duty migrations so that future requests directed to the powered down device may be handled effectively by another interchangeable device. In some cases, when it is desired to reactivate all of the components, that entity is aware of how to redistribute the duties in accordance with the original design distribution. The entity that keeps track of migrations may be a virtual machine or a software partitioning mechanism, as two examples.

Thus, in some cases, the entity may be the virtual machine 20 which may trap accesses to powered down devices and may redirect those accesses to other interchangeable components that are handling the duties of the powered down device. In some embodiments, the virtual machine 20 may maintain mapping tables, to indicate the migrations, in a memory controller or other location, such as the dynamic random access memory 18. Thus, the virtual machine 20 may be a virtual machine monitor or VMM which acts as a hypervisor or supervisor of the system 10. In the case of a memory imbalancing, the virtual machine monitor may allow trapping of memory accesses.

In some embodiments of the present invention, components may be powered down to conserve power and powered back up when they are needed. The powering down may be implemented, in some embodiments, using the hot-remove capability which is also present in many bus agents. The replacement of those devices may be done using hot-adding which also is available in ACPI specification component devices.

Thus, the physical removal of a deactivated device may be simulated by the hot-remove so that thereafter, the operating system and other components would not expect to use such a device. As a result, calls to the powered down or hot-removed device may no longer be made, in some cases reducing or eliminating the need for an entity which monitors and redirects responsibilities of powered down devices, such as a virtual machine.

As still another embodiment, maintenance of the mapping between active and powered down devices may be done by an operating system driver, instead of a virtual machine monitor. The driver may be responsible for implementing hot plugging including hot-add, as well as hot-remove.

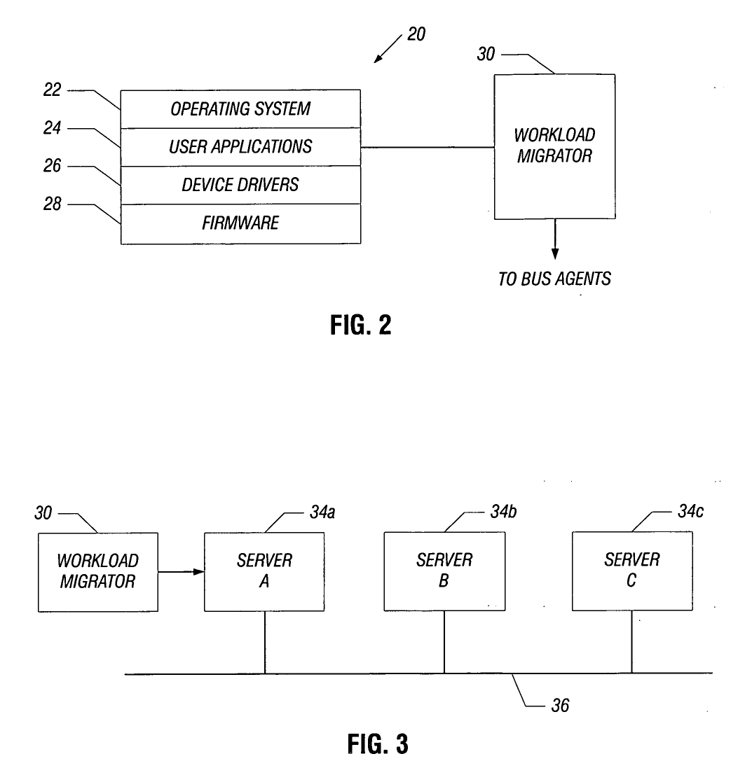

Referring to FIG. 2, in some embodiments of the present invention, the workload migrator 30 may be part of the entity 20. The workload migrator is an entity which may be implemented in hardware, software, or firmware to keep track of which interchangeable components have been hot-removed or powered down and the corresponding components which now are taking over the duties of any hot-removed or powered down components.

Thus, requests for services from bus agents, for example, from the operating system 22, the user applications 24, device drivers 26, and firmware 28 may be trapped or otherwise diverted to the workload migrator 30 which, thereafter, distributes the workload according to the power consumption aims of the system. Namely, duties may be redistributed to replacement components handling the duties of a powered down or hot-removed component. In some embodiments such redistribution may be done without advising the work requester.

Referring to FIG. 3, in accordance with another embodiment of the present invention, a plurality of servers 34a-34c may be coupled to a bus 36. The servers 34a-c, in one embodiment, may be blade servers which are maintained in a common rack. As a result, the servers 34a-c may be prone to overheating caused by the cumulative impact of the heat generated by numerous servers in the same rack. In some embodiments, the workload migrator 30 may be stored so as to be accessible by one or more of the servers 34a-c, such as a server 34a. As a result, the server 34a, which maintains the workload migrator 30 in one embodiment, may then operate the servers 34b and 34c to power those servers up and down to conserve power.

As an example, the workload migration may be based on the current workload requirements of the system. For example, if the current workload requirements of the system are sufficiently low, it may be unnecessary to maintain multiple interchangeable components in their active, power consuming states. Examples of the considerations which might be implemented through a heuristic or software system, in some embodiments, include how heavily used are the available components and how spread out is that use within those components. In other words, in situations where the use is low but the responsibilities are spread among a number of components, it may be advisable to reduce the number of components used and, thereby, reduce power consumption.

Thereafter, in some cases, it may be desirable to avoid reprogramming the entire system to accommodate the modifications implemented to reduce power consumption. In such cases, accesses to the powered down or hot-removed components may be reallocated by an entity, such as a virtual machine monitor, which traps accesses to the powered down components.

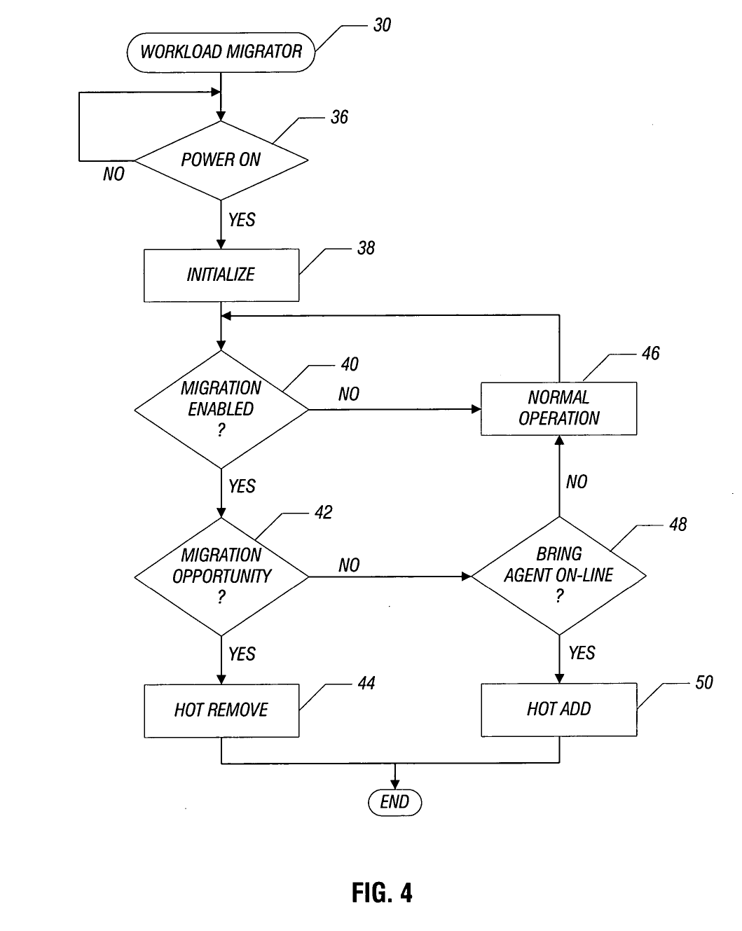

Referring to FIG. 4, in accordance with some embodiments of the present invention, the workload migrator 30 process may be implemented. In some embodiments, the workload migrator 30 may be software which may, for example, be stored on the memory 18, for example, as a virtual machine monitor, as a driver, as part of the operating system, or as an application, to provide a few examples.

Initially, the workload migrator 30 determines whether the system is powered on as indicated at 36. If so, the various components may be initialized as indicated in block 38. This initialization may include configuration of the various components pursuant to a conventional configuration cycle. Thus, logs may be developed to indicate the numbers and identities or addresses of interchangeable components of a given type.

At diamond 40, a check determines whether or not workload migration has been enabled. If not, normal operation is implemented as indicated in block 46.

If workload migration has been enabled, either as a general setting or because of specific conditions or circumstances within the system, a check at diamond 42 determines whether a migration opportunity is present. The activation of workload migration may be a general setting which is or is not set at any given time. In addition, the workload of the system may precipitate enablement of workload migration. For example, low activity on the system or high power consumption, high heat generation, temporarily switching to battery power, or reduced available battery charge may all be examples of things which would initiate automatic workload migration enablement.

A migration opportunity is a situation of the type described above where a given operation is being handled by more than one interchangeable component and the needs of the system do not require that multiple components be active in consuming full power.

If a migration opportunity does not exist, a check at diamond 48 determines whether any component should be brought online. In other words, if the workload is sufficiently high and the spreading of responsibility sufficiently low, it may be necessary to power up or hot-add a component which was previously powered down or hot-removed. If so, a hot-add may be automatically implemented in one embodiment, as indicated in block 50.

On the other hand, if a migration opportunity exists, in one embodiment, a component may be hot-removed as indicated in block 44. Alternatively, the component may be simply powered down and an entity, such as the virtual machine 20, may be utilized to redirect subsequent accesses to the powered down component to its replacements. In addition, the hot-remove may, in some cases, require the off loading of data stored on the removed component. For example, the hot-removed component may be memory storing data that must be transitioned to another memory. The reallocation of the new memory may be monitored by the virtual machine 20 or other entity. Thereafter, subsequence accesses may be redirected appropriately to the replacement interchangeable component.

An another example, a software partitioning mechanism may be used as the entity 20 to keep track of the migrations, instead of the virtual machine 20. The partitioning mechanism normally keeps track of software partitions which may operate independently of one another. That mechanism can also be called upon to keep track of which responsibilities have been migrated to or from components.

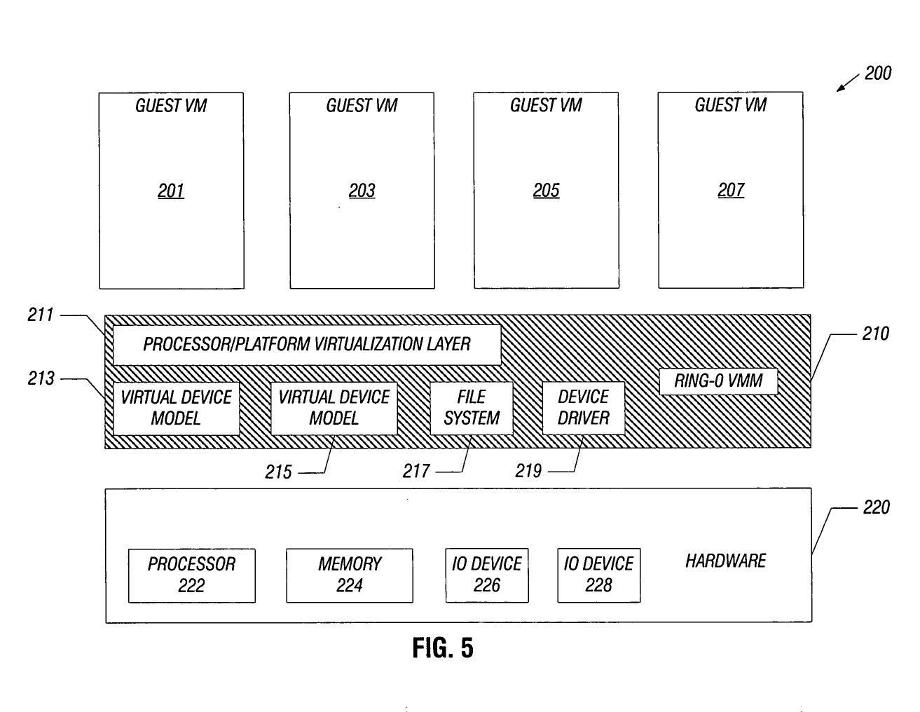

FIG. 5 is a block diagram illustrating traditional hypervisor VMM architecture platform 200. A number of guest virtual machines (VMs) 201, 203, 205, and 207 may be running on the platform 200 at the same time. A virtual machine monitor (VMM) 210 controls the guest VMs′ access to the hardware 220 via the processor/platform virtualization layer 211. The monitor 210, in one embodiment, may act as the entity 20 that keeps track of duty migrations. A number of virtual device models 213 and 215 may exist within the VMM 210. The VMM 210 may operate at the highest privilege level. The VMM 210 controls access to the file system, memory, and all devices, as discussed further below. The VMM 210 typically has a device driver 219 for each hardware device on the platform.

The VMM 210 and guest VMs 201, 203, 205, and 207 execute on platform hardware 220. The platform hardware 220 may include a processor 222, memory 224, and one or more I/O devices 226 and 228. The platform hardware 220 may be a personal computer (PC), mainframe, handheld device, portable computer, set top box, or any other computing system.

Processor 222 may be any type of processor capable of executing software, such as a microprocessor, digital signal processor, microcontroller, or the like. Though FIG. 2 shows only one such processor 222, there may be one or more processors in platform hardware 220 and one or more of the processors may include multiple threads, multiple cores, or the like.

Memory 224 may be a hard disk, a floppy disk, random access memory (RAM), read only memory (ROM), flash memory, or any other type of medium readable by processor 222. Memory 224 may store instructions for performing the execution of method embodiments of the present invention.

The one or more I/O devices 226 and 228 may be, for example, network interface cards, communication ports, video controllers, disk controllers on system buses (e.g., Peripheral Component Interconnect (PCI), Industry Stanard Architecture (ISA), Advanced Graphics Port (AGP)), devices integrated into the chipset logic or processor (e.g., real-time clocks, programmable timers, performance counters), or any other device on the platform hardware 220. The one or more I/O devices 226 and 228 may be accessed through I/O instructions, or memory mapped I/O accesses or through any other means known in the art.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
reducing power consumption of interchangeable first and second components by powering down the first component and migrating the duties of the first component to the second component.

2. The method of claim 1 including reducing the power consumption of interchangeable processors by powering down a first processor and migrating its duties to a second processor.

3. The method of claim 1 including reducing power consumption by powering down a first memory and migrating its duties to a second memory.

4. The method of claim 1 including migrating both duties and stored data from the first component to the second component.

5. The method of claim 1 including automatically implementing a hot-remove to remove the first component.

6. The method of claim 1 including providing an entity to keep track of which components have been powered down and redirect accesses to those components to other interchangeable components.

7. The method of claim 6 including using as the entity a virtual machine monitor to reduce power consumption.

8. The method of claim 7 including using the virtual machine monitor to trap accesses to a powered down first component.

9. The method of claim 1 including operating a plurality of servers and reducing power consumption by powering down a first server and migrating its duties to a second server.

10. The method of claim 1 including automatically detecting an opportunity to reduce power consumption and automatically powering down the first component in response to the detection of the opportunity.

11. A machine readable medium storing instructions that when executed cause a system to:
reduce power consumption of interchangeable first and second components by powering down the first component and migrating the duties of the first component to the second component.

12. The medium of claim 11 further storing instructions to reduce the power consumption of interchangeable processors by powering down a first processor and migrating its duties to a second processor.

13. The medium of claim 11 further storing instructions to reduce power consumption by powering down a first memory and migrating its duties to a second memory.

14. The medium of claim 11 further storing instructions to migrate both duties and stored data from the first component to the second component.

15. The medium of claim 11 further storing instructions to automatically implement a hot-remove to remove the first component.

16. The medium of claim 11 further storing instructions to provide an entity to keep track of which components have been powered down and redirect accesses to those components to other interchangeable components.

17. The medium of claim 16 further storing instructions to use a virtual machine monitor to reduce power consumption.

18. The medium of claim 17 further storing instructions to use the virtual machine monitor to trap accesses to a powered down first component.

19. The medium of claim 11 further storing instructions to operate a plurality of servers and reduce power consumption by powering down a first server and migrating its duties to a second server.

20. The medium of claim 11 further storing instructions to automatically detect an opportunity to reduce power consumption and automatically powering down the first component in response to the detection of the opportunity.

21. An apparatus comprising:
an interchangeable first component;
an interchangeable second component; and
a workload migrator to reduce power consumption of said components by powering down the first component and migrating the duties of the first component to the second component.

22. The apparatus of claim 21 wherein said first and second components are storage devices.

23. The apparatus of claim 21 wherein said first and second components are servers.

24. The apparatus of claim 21 wherein said first and second components are bus agents.

25. The apparatus of claim 21 including an entity to keep track of duty migrations, said entity including a virtual machine, a software partitioning mechanism, or an operating system driver.

26. A system comprising:
a processor; and
a workload migrator coupled to said processor to automatically power down a first component and migrate the duties of the first component to a second component to reduce power consumption.

27. The system of claim 21 wherein said system includes a plurality of servers.

28. The system of claim 21 including at least two processors.

29. The system of claim 28 wherein each of said first component and said second component includes a processor.

30. The system of claim 26 wherein said first component and said second component each include a semiconductor memory and said workload migrator to transfer data from said first component to said second component.
